(19) United States
(12) Patent Application Publication
(10) Pub. No.: US 2024/0273354 A1
(43) Pub. Date: Aug. 15, 2024

(54) DATA MANAGEMENT SYSTEM USING NEURAL NETWORKS AND RISK MODELING

(71) Applicant: International Business Machines Corporation, Armonk, NY (US)

(72) Inventors: Bing ZHANG, San Jose, CA (US); Shubhi ASTHANA, Santa Clara, CA (US); Pawan Raghunath CHOWDHARY, San Jose, CA (US); Taiga NAKAMURA, Sunnyvale, CA (US)

(21) Appl. No.: 18/167,855

(22) Filed: Feb. 11, 2023

(51) Int. Cl. G06N 3/08

(52) U.S. Cl. CPC G06N 3/08

(57) ABSTRACT

A data management system may receive, via a network and from different computing devices, first data regarding a plurality of first documents and second data regarding a plurality of second documents. The system may perform a correlation coefficient analysis to identify a subset of labels and train a neural network model, based on the subset of labels, to determine a mapping between the plurality of first documents and the plurality of second documents. The mapping may indicate that one or more second documents are associated with a particular first document. The system may train a time-series forecasting model to predict one or more second documents for the particular first document. The system may perform a risk analytics process on the particular first data to determine a measure of risk associated with the particular first document. The system may evaluate the particular first data dynamically using a reinforcement learning model.

The following disclosure(s) are submitted under 35 U.S.C. 102(b)(1)(A): DISCLOSURE(S): System and Method on Order Management Using Neural Networks and Risk Modeling, 2022 IEEE International Conference on Big Data (Big Data), Shubhi Asthana et al., Dec. 17, 2022, pages 1979-1986.

### BACKGROUND

The present invention relates to a data management system, and more specifically, to a data management system that uses neural networks and risk modeling to ensure the completion of transactions. A purchase order management system may include one or more computing devices that are configured to monitor all stages of multiple transactions and are configured to ensure the completion of the transactions.

### SUMMARY

In some implementations, a computer-implemented method comprises: receiving, via a network, first data regarding a plurality of first documents and second data regarding a plurality of second documents. The first data and the second data are received from different devices; performing a correlation coefficient analysis to identify a subset of labels. The computer-implemented method further comprises training a neural network model based on the subset of labels to determine a mapping between the plurality of first documents and the plurality of second documents. The mapping indicates that one or more second documents, of the plurality of second documents, are associated with a particular first document of the plurality of first documents. The computer-implemented method further comprises training a time-series forecasting model to predict one or more second documents for the particular first document; and performing a risk analytics process on particular first data, of the particular first document, to determine a measure of risk associated with the particular first document. The measure of risk is determined based on the one or more forecasted second documents. The computer-implemented method further comprises evaluating the particular first data dynamically using a reinforcement learning model; and performing one or more recommended actions based on evaluating the particular first data. The particular first data is evaluated based on the measure of risk.

In some implementations, a computer program product comprises: one or more computer readable storage media, and program instructions collectively stored on the one or more computer readable storage media, the program instructions comprising: program instructions to receive purchase order (PO) data regarding one or more purchase orders (POs) and invoice data regarding a plurality of invoices; program instructions to perform a correlation coefficient analysis to identify a subset of labels; program instructions to train a neural network model based on the subset of labels to determine a mapping between the plurality of invoices and the one or more POs; program instructions to generate a time-series forecasting model to predict one or more forecasted invoices for the particular PO; program instructions to perform a risk analytics process on particular PO data, of the particular PO data, to determine a measure of risk associated with the particular PO; program instructions to evaluate the particular PO data dynamically using a reinforcement learning model; and program instructions to perform recommended actions based on evaluating the particular PO data. The one or more invoices, of the plurality of invoices, are associated with a particular PO of the one or more POs. The measure of risk is determined based on the one or more forecasted invoices. The particular PO data is evaluated based on the measure of risk.

In some implementations, a system comprises: one or more devices configured to: perform a correlation coefficient analysis to identify a subset of labels; train a neural network model based on the subset of labels to determine a mapping between a plurality of invoices and a plurality of purchase orders (POs); train a time-series forecasting model to predict one or more forecasted invoices for the particular PO; determine a measure of risk associated with the particular PO; evaluate particular PO data, of the particular PO, dynamically using a reinforcement learning model; and perform recommended actions based on evaluating the particular PO data. The mapping indicates that one or more invoices, of the plurality of invoices, are associated with a particular purchase order (PO) of the plurality of POs. The measure of risk is determined based on the one or more forecasted invoices. The particular PO data is evaluated based on the measure of risk.

### BRIEF DESCRIPTION OF THE DRAWINGS

FIGS. 1A-1E are diagrams of an example implementation described herein.

FIG. 2 is a diagram of an example computing environment in which systems and/or methods described herein may be implemented.

FIG. 3 is a diagram of example components of one or more devices of FIGS. 1 and 2.

FIG. 4 is a flowchart of an example process relating to time-series forecasting using multivariate time-series data with missing values.

### DETAILED DESCRIPTION

The following detailed description of example implementations refers to the accompanying drawings. The same reference numbers in different drawings may identify the same or similar elements.

A service provider may utilize a purchase order management system to monitor transactions between the service provider and multiple customers. The purchase order management system may include computing devices that are used to monitor electronic documents (e.g., purchase orders) that are issued by customers. Additionally, the purchase order management system may be used to monitor additional electronic documents (e.g., invoices) that are issued by the service provider. Typically, every month, more than thousands of invoices are billed to customers. Each purchase order has a unique number (known as PO number) that is used to monitor the delivery of a service associated with the purchase and payment for the service.

The process of generating, storing, and monitoring the purchase orders and the invoices may be complex and intertwined. For example, the purchase order management system may be used to generate, store, and monitor a large number of purchase orders and invoices which may consume a considerable amount of computing resources, storage resources, and/or network resources, among other examples.

Additionally, data regarding purchase orders and data regarding invoices may be stored in different file systems. The file systems may be maintained in different cloud systems. Storing data in different cloud systems creates complexity with respect to data mapping between purchase orders and the corresponding invoices. The complex data mapping may be performed by one or more computing devices. In this regard, performing complex data mapping may consume a considerable amount of computing resources, storage resources, and/or network resources, among other examples.

Furthermore, storing the data regarding purchase orders and the data regarding invoices in different file systems creates discrepancies with respect to the amount of funds allocated for the purchase orders, with respect to portions of the amount of funds utilized by invoices associated with the purchase orders, and/or with respect to expiration dates of the purchase orders. For example, disputes may arise with respect to exhaustion of allocated funds and with respect to generating invoices for an expired purchase order (e.g., with respect to generating invoices for an expired purchase order).

The discrepancies may be remedied using one or more computing devices. In this regard, remedying the discrepancies may consume a considerable amount of computing resources, storage resources, and/or network resources, among other examples. Accordingly, a need exists for an efficient system for managing order data including a large number of invoices and purchase orders; and determining actions regarding the invoices and purchase orders. The actions may be directed to increasing renewals of purchase orders and to reducing and avoiding disputes due to the over-exhaustion of allocated funds or due to generating invoices for expired purchase orders.

Implementations described herein provide solutions to overcome the above issues relating to the data regarding purchase orders (POs) and the data regarding invoices that are provided in different file systems. For example, implementations described herein are directed to a method, a system, and a framework of mapping purchase orders and invoices (e.g., obtained from different systems) and assessing risks associated with the purchase orders using a natural language processing (NLP) model, a neural network model, a time-series forecasting model, and a reinforcement learning model. The method, the system, and the framework may include an automated purchase order-invoice data mapping model (e.g., a model for mapping POs and invoices) along with a risk analytics model that evaluates POs against invoices billed, and an action recommendation model.

In some examples, implementations described herein are directed to data management system that is configured to receive first data regarding a plurality of first documents and second data regarding a plurality of second documents. The first data and the second data may be received via a network from multiple computing devices. The first data and the second data may be stored in different file systems. In some situations, the first data may be purchase order (PO) data regarding one or more POs and the second data may be invoice data regarding a plurality of invoices. In this regard, the data management system may be a purchase order management system.

The data management system may parse the first data and the second data to identify labels of the plurality of the first documents and labels of the plurality of the second documents. In some examples, the data management system may analyze the first data and the second data to determine matches between labels of the first documents (e.g., PO labels of POs) and labels of the second documents (e.g., invoice labels of invoices).

The data management system may assign values based on analyzing the first data and the second data to determine the matches. A first value may indicate a match between a first label of the particular first document and a second document label of a second document. A second value may indicate a mismatch between a second document label of the particular first document and a second document label of the second document. The values may be included in a data structure.

The data management system may perform a correlation coefficient analysis using the values of the data structure, to identify a subset of the labels of the first documents and a subset of the labels of the second documents that are most correlated. The data management system may train a neural network model to determine matches between the first documents and the second documents. The neural network model may be trained using data regarding the subset of the labels of the first documents and the subset of the labels of the second documents.

The data management system may train a time-series forecasting model to determine (or predict) one or more forecasted second documents for a particular first document. For example, the data management system may train a time-series forecasting model to predict one or more forecasted invoices for a particular purchase order. The data management system may determine a risk factor associated with the first document.

For example, the data management system may perform a risk analysis process to determine a measure of risk for a particular PO for the next billing cycle of the PO. The risk factor may indicate a likelihood of a dispute arising with respect to one or more forecasted invoices. The risk factor may be based on the remaining amount of the PO and a projected amount of a forecasted invoice associated with the next billing cycle.

The data management system may determine the performance of the particular first document. For example, the data management system may determine the performance of a particular PO based on the risk factor, a customer portfolio associated with the particular PO, and past performance of the particular PO.

The data management system may evaluate the particular first data, of the particular first document, dynamically using a reinforcement learning model. For example, the data management system may determine the impact of actions on the performance of the PO. For example, the data management system may evaluate an impact factor associated with the actions on the performance of the particular PO. The data management system may perform the actions based on evaluating the impact factor.

One advantage of implementations described herein is to preserve computing resources, network resources, and other resources that would have otherwise been used to perform complex data mapping. Another advantage of implementations described herein is to preserve computing resources, network resources, and other resources that would have otherwise been used to remedy discrepancies with purchase orders and invoices.

While examples herein may be described with respect to purchase orders and invoices, implementations described herein are generally applicable to mapping different types of electronic documents and assessing risks associated with electronic documents (e.g., of a particular type) using an NLP model (or NLP algorithm), a neural network model, a time-series forecasting model, and/or a reinforcement learning model.

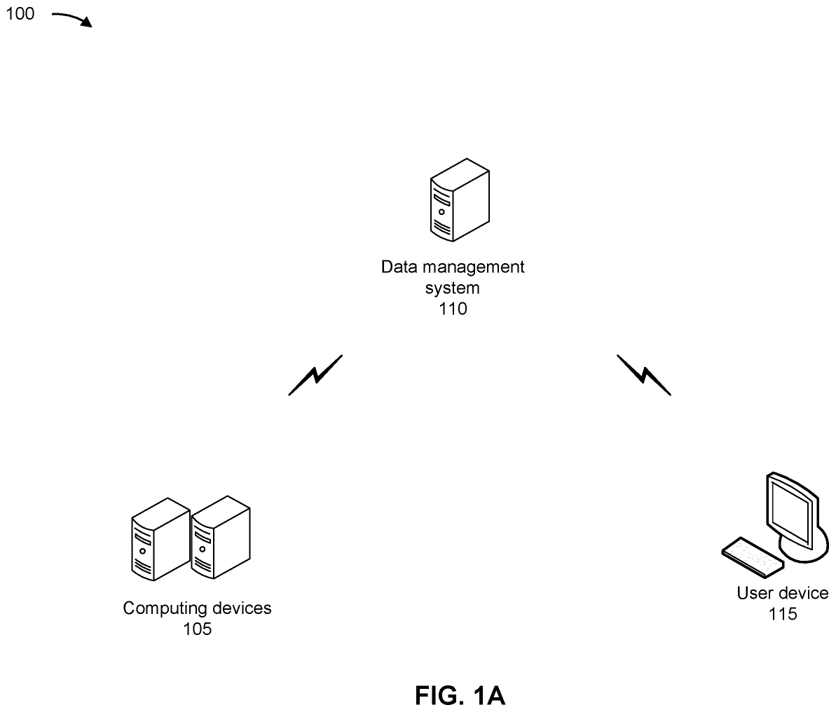

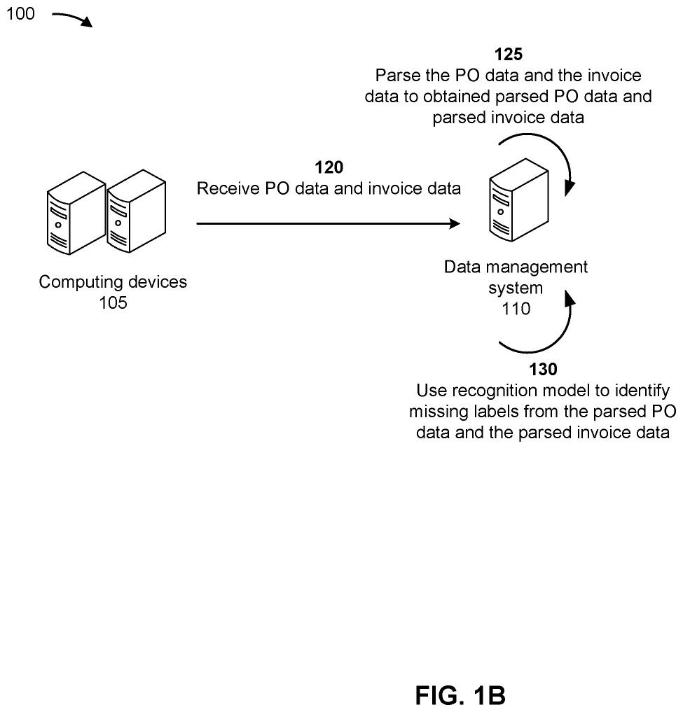

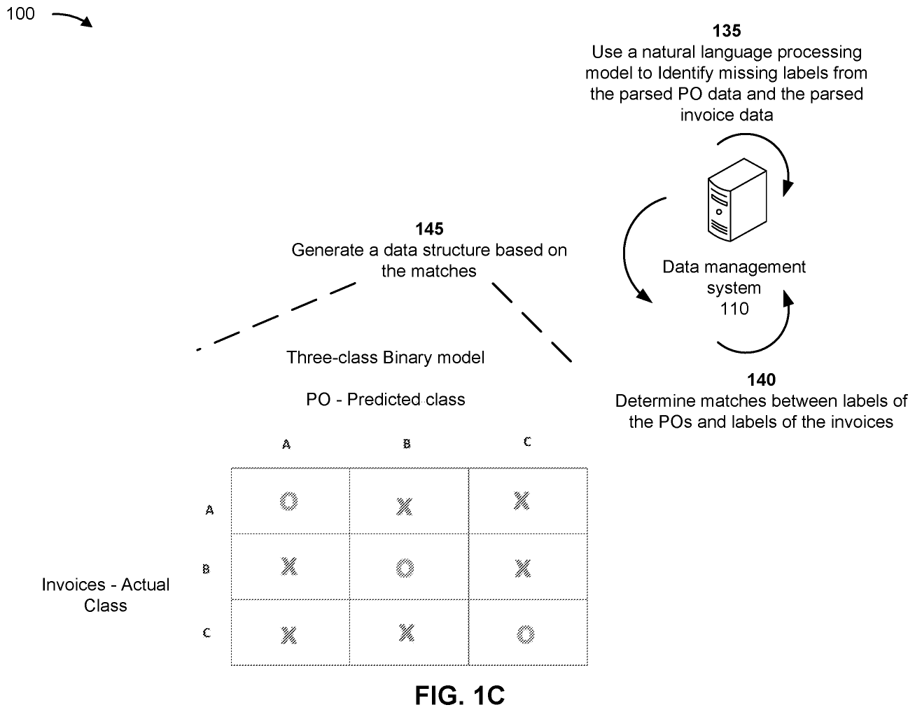

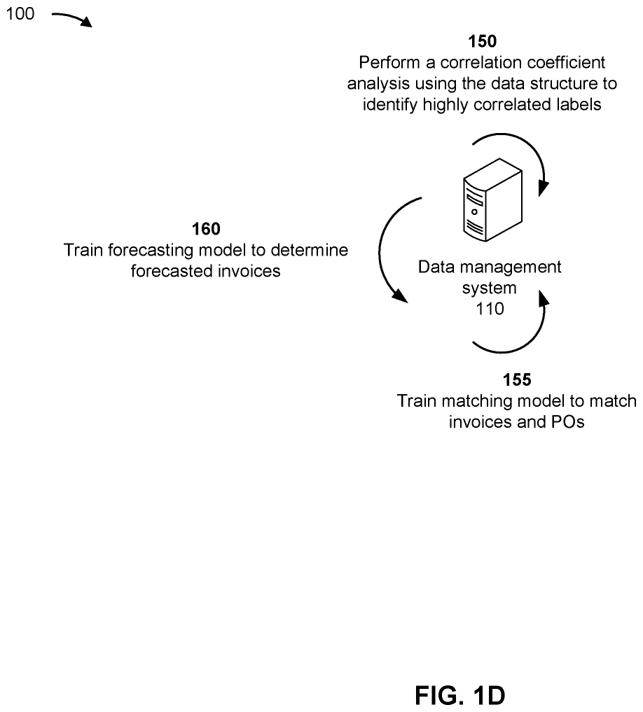

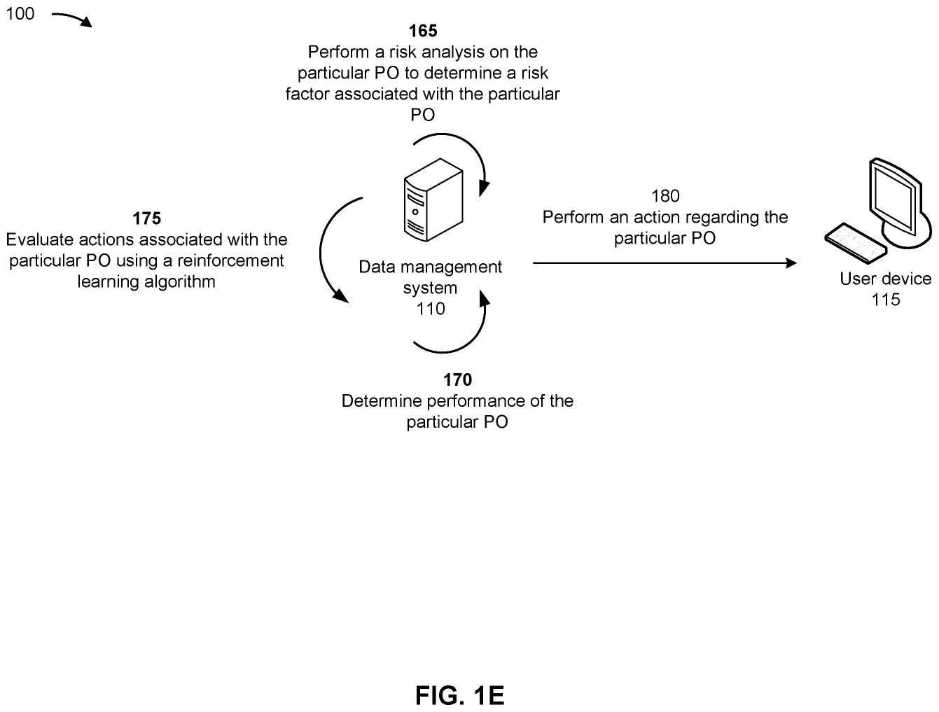

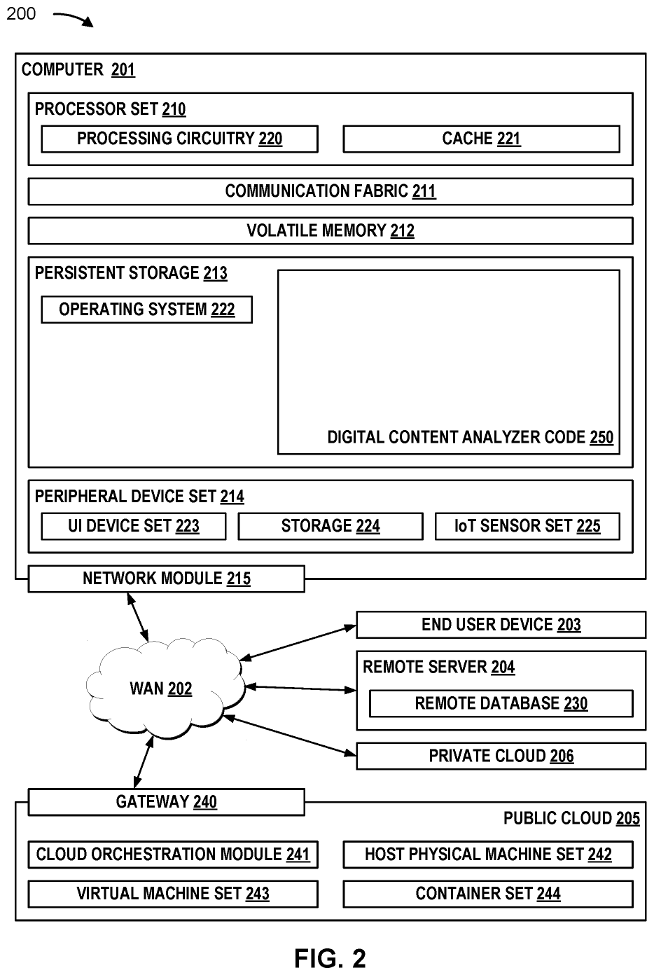

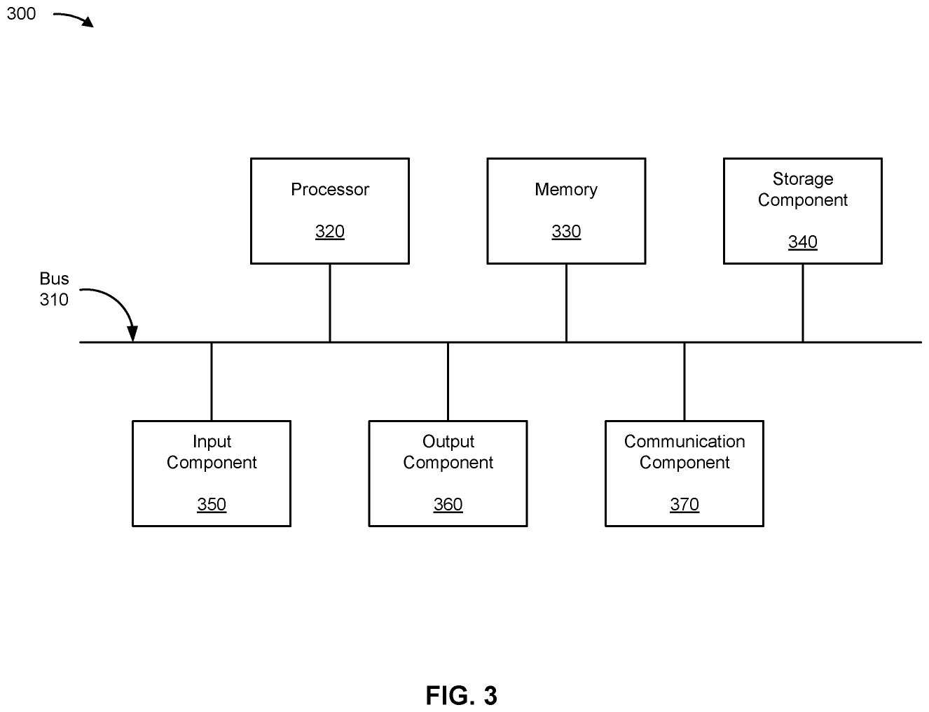

FIGS. 1A-1E are diagrams of an example implementation 100 described herein. As shown in FIGS. 1A-1E, example implementation 100 includes computing devices 105 (individually “a computing device 105”), a data management system 110, and a user device 115. These devices are described in more detail below in connection with FIG. 2 and FIG. 3. One or more computing devices 105, data management system 110, and user device 115 may be connected via wired connections, wireless connections, or a combination of wired and wireless connections.

For example, one or more computing devices 105, data management system 110, and user device 115 may be connected via a network that includes one or more wired and/or wireless networks. For example, the network may include Ethernet switches. Additionally, or alternatively, the network may include a cellular network, a public land mobile network (PLMN), a local area network (LAN), a wide area network (WAN), a private network, the Internet, and/or a combination of these or other types of networks. The network enables communication between one or more computing devices 105, data management system 110, and user device 115.

A computing device 105 may include one or more devices configured to receive, generate, store, process, and/or provide information associated with mapping invoices to purchase orders and assessing risks associated with the purchase orders, as explained herein. In some examples, a computing device 105 may be configured to generate PO data regarding a plurality of POs. Additionally, or alternatively, the computing device 105 may be configured to generate invoice data regarding a plurality of invoices.

Data management system 110 may include one or more devices configured to receive, generate, store, process, and/or provide information associated with mapping invoices to POs and assessing risks associated with the POs, as explained herein. In some examples, data management system 110 may be configured to map invoices to POs and determine measures of risks associated with the POs, as described herein.

User device 115 may include one or more devices configured to receive, generate, store, process, and/or provide information associated with mapping invoices to POs and assessing risks associated with the POs, as explained herein. User device 115 may include a communication device and a computing device. For example, user device 115 may include a wireless communication device, a mobile phone, a user equipment, a laptop computer, a tablet computer, a desktop computer, or a similar type of device.

As shown in FIG. 1B, and by reference number 120, data management system 110 may receive PO data and invoice data. For example, data management system 110 may receive PO data regarding a plurality of POs and invoice data regarding a plurality of invoices. Each invoice may be associated with a respective PO of the plurality of POs.

Data management system 110 may receive the PO data and the invoice data from computing devices 105. In some situations, data management system 110 may receive the PO and the invoice data based on a request to map the plurality of invoices and the plurality of POs and/or to determine measures of risk associated with the plurality of POs. The request may be received from user device 110.

In some examples, data management system 110 may receive the PO data from one or more first computing devices 105 and receive the invoice data from one or more second computing devices 105. The PO data and the invoice data may be stored in different file systems. The file systems may be included in different cloud systems. In some situations, each computing device 105 may be associated with a respective file system. The file system may include a data structure configured to control a way data is stored and/or retrieved (or accessed). In some examples, each file system may be associated with a respective data format.

As shown in FIG. 1B, and by reference number 125, data management system 110 may parse the PO data (e.g., the PO document) and the invoice data (e.g., the invoice document) to obtain parsed PO data (e.g., parsed PO document) and parsed invoice data (e.g., parsed invoice document). In some examples, data management system 110 may parse the PO data and the invoice data using a parsing algorithm.

In some examples, data management system 110 may parse the PO document and the invoice document into a JavaScript Object Notation (JSON) format file. In some implementations, data management system 110 may extract the PO data and the invoice data from parsed files to facilitate identifying labels included in the POs and labels included in the invoices and facilitate determining labels that are missing from the POs and the invoices. If the PO data and the invoice data are already in a structured format (e.g., in a spreadsheet format), data management system 110 may not use an NLP model (e.g., an entity recognition NLP model) to extract data from JSON files after parsing PO documents and invoice documents. Alternatively, if data is missing from certain data features/labels, then the NLP model may be used to process data for features/labels extraction.

As shown in FIG. 1B, and by reference number 130, data management system 110 may use a named entity recognition model to identify missing labels from the parsed PO data and the parsed invoice data. For example, after parsing the PO data and the invoice data, data management system 110 may use the named entity recognition model to identify entities of interest (labels) included in the POs and entities of interest (labels) included in the invoices.

The named entity recognition model may be a rule-based model that uses pattern matching to identify the entities of interest (e.g., identify labels). The recognition model may be used to identify key labels pairs in a portion of the parsed PO data and a portion of the parsed invoice data (collectively “structured data”). In some examples, the labels may be pre-defined (or pre-determined), for example by a user (e.g., a user associated with user device 115). For instance, the labels (e.g., for the POs) may include vendor identifiers that identify vendors associated with the POs, PO identifiers that identify the POs, and/or country codes that identify countries associated with the POs, among other examples.

Additionally, or alternatively, the labels (e.g., for the invoices) may include vendor identifiers that identify vendors associated with the invoices, invoices identifiers that identify the invoices, and/or country codes that identify countries associated with the invoices, among other examples. In some examples, after identifying the labels included in the parsed PO data and in the parsed invoice data, data management system 110 may determine labels that are missing from a remaining portion of the parsed PO data and a remaining portion of the parsed invoice data (collectively “unstructured data”).

As shown in FIG. 1C, and by reference number 135, data management system 110 may use an NLP model to identify missing labels from the parsed PO data and the parsed invoice data. In some implementations, data management system 110 may perform text mining and train (or develop) the NLP model to extract relevant missing values from the unstructured data (e.g., PO documents) and pair the missing values with appropriate labels. In some implementations, data management system 110 may perform the text mining using the NLP model. For example, data management system 110 may train the NLP model to identify text that relates to the labels and to associate the text to the labels.

In this regard, data management system 110 may provide the unstructured data and information identifying the missing labels as input to the NLP model. The NLP model may provide, as an output, different portions of text that are associated with the missing labels. In some situations, data management system 110 may repeat the actions regarding the NLP model multiple times if data management system 110 determines that labels remain missing from one or more POs and/or from one or more invoices. In this regard, data management system 110 may receive input from a user (e.g., a human-in-the-loop input) that identifies missing labels. Additionally, or alternatively, data management system 110 may utilize a support vector machine classification model to identify the missing labels.

As shown in FIG. 1C, and by reference number 140, data management system 110 may determine matches between labels of the POs and labels of the invoices. In some implementations, data management system 110 may compare each invoice and each PO. For example, data management system 110 may compare invoice features (e.g., labels) of a first invoice and PO feature of a first PO, compare the invoice features of the first invoice and PO feature of a second PO, and so on until the first invoice has been compared to all invoices. Data management system 110 may repeat the same actions for all invoices.

In some examples, when comparing the first invoice and each PO, data management system 110 may compare a first invoice feature and PO features of each PO, compare a second invoice feature and PO features of each PO, and so on. For instance, data management system 110 determine whether rules of the invoice features of the first invoice match rules of the PO features of the first PO. As an example, data management system 110 may determine that the first invoice is associated with the first PO if one or more invoice features of the first invoice match one or more PO features of the first PO. For instance, data management system 110 may determine that the first invoice is associated with the first PO is a country code of the first invoice matches a country code of the first PO and/or if a vendor identifier of the first PO matches a vendor identifier of the first PO.

As shown in FIG. 1C, and by reference number 145, data management system 110 may generate a data structure based on the matches. In some implementations, the data structure may include rows of information regarding the invoices (e.g., invoice features) and columns of information regarding the POs (e.g., PO features). Management system 110 may assign a first value (e.g., “1”) to indicate a match between an invoice feature (or a label) of an invoice and a PO feature (or a label) of a PO. Alternatively, data management system 110 may assign a second value (e.g., “0”) to indicate no match between an invoice feature (or a label) of an invoice and a PO feature (or a label) of a PO.

Based on the foregoing, the PO data and the invoice data may be transformed (or converted) to a binary feature dataset. The data structure may include multiple entries with the first value and the second value.

As shown in FIG. 1D, and by reference number 150, data management system 110 may perform a correlation coefficient analysis using the data structure to identify highly correlated labels. For example, data management system 110 may perform the correlation coefficient analysis after determining the matches as explained above. In some examples, the correlation coefficient analysis may be a Pearson correlation coefficient analysis.

Data management system 110 may use the correlation coefficient analysis to identify labels of the PO data and labels of the invoice data that are most correlated (e.g., labels that are most matched).

As shown in FIG. 1D, and by reference number 155, data management system 110 may train a matching model to match invoices and POs. For example, data management system 110 may train a neural network model to determine matches between POs and invoices. In some implementations, data management system 110 may train the neural network model using information regarding the labels that are most correlated. Accordingly, the neural network model may be trained to determine matches between the POs and the invoices based on the most correlated labels. In this regard, the neural network model may be used to further classify, pair, and group of POs and of invoices.

As shown in FIG. 1D, and by reference number 160, data management system 110 may train a forecasting model to determine (or predict) forecasted invoices. For example, data management system 110 may train a time-series forecasting model to predict invoices for a particular PO of the POs identified by the PO data. In some examples, the time-series forecasting model may be a time-series Prophet forecasting model or a long short-term memory (LSTM) model.

In some implementations, as part of a process for training the forecasting model, data management system 110 may analyze the invoice data of invoices associated with the particular PO (e.g., invoices issued for the particular PO). Data management system 110 may aggregate amounts billed using the invoices over time as an aggregated amount and compared the aggregated amount and an amount allocated for the particular PO. In some examples, data management system 110 may determine the remaining amount for the particular PO using the following formula:

$${P}_{al} = {P}_{a} - \sum {B}_{a} \qquad ( Formula 1 )$$

Where Pₐ is the amount allocated for the particular PO, Pₐₗ is the remaining amount for the particular PO, and Bₐ is the amount billed for each invoice.

In some implementations, data management system 110 may train the forecasting model to analyze a trend in historical data regarding historical invoices for the particular PO.

Based on analyzing the historical data, the forecasting model may generate (or predict) forecasted data regarding forecasted invoices for the particular PO. As an example, the forecasting model may be trained using historical data regarding historical invoices that occurred over a first period of time (e.g., a number of months) and may be trained to generate forecasted data that indicate one or more forecasted invoices along with an expected amount for each of the one or more forecasted invoices.

In some situations, data management system 110 may determine an expected amount for a forecasted invoice using the following formula:

$$Expected amount = \frac{{P}_{al}}{N} \qquad ( Formula 2 )$$

Where Pₐₗ is the remaining amount for the particular PO and N is the number of expected invoices.

In some examples, data management system 110 may determine N based on a number of billing cycles of the particular PO. For example, if the invoices (for the particular PO) are issued on a monthly basis, and if 10 invoices have been issued over a period of time, data management system 110 may determine that N is 2 over a calendar year.

As shown in FIG. 1E, and by reference number 165, data management system 110 may perform a risk analysis on the particular PO to determine a risk factor associated with the particular PO. For example, data management system 110 may determine a risk factor (or a measure of risk) for an nth invoice cycle from a current cycle of the particular PO.

As an example, if the invoices for the particular PO are issued monthly, and if invoices have been for January to November, the forecasting model may predict information for the nth invoice cycle which is for the month of December. The risk factor may represent a number of invoices that can be covered by the remaining amount for the particular PO. In this regard, data management system 110 may determine the risk factor based on the remaining amount for the PO and the projected amount for the nth invoice cycle (or the n^{th} invoice).

In some implementations, data management system 110 may determine the risk factor using the following formula:

$$R = \frac{{P}_{al} - ( n \times {Proj}_{a} )}{{Proj}_{a}} \qquad ( Formula 3 )$$

where R is the risk factor (or measure of risk), Pₐₗ is the remaining amount for the particular PO, n is the number of cycles from the current cycle, and Projₐ is the projected amount for the nth invoice cycle.

Data management system 110 may determine different categories of risk factors. The different categories may include overbilled risk, high risk, medium risk, and low risk. In some implementations, data management system 110 may determine the different categories of risk factors as follows:

TABLE 1

| Risk Category | Expression |
|---|---|
| Overbilled Risk | Pₐₗ < 0 |
| High Risk | (R < 1 AND Iₚ > 0) OR |
| | (Pₐₗ > −10 AND Pₐₗ ≤ 0 AND Iₚ > 0) OR |
| | PO expired or expiring in 30 days |
| Medium Risk | (R ≥ 1 AND R < Iₚ) OR |
| | PO expiring in 30 to 60 days |
| Low Risk | If none of above conditions are satisfied |

where R is the risk factor, Pₐₗ is the remaining amount for the particular PO, Iₚ is the pending invoices for the particular PO within that time period.

As shown in FIG. 1E, and by reference number 175, data management system 110 may evaluate actions associated with the particular PO using a reinforcement learning model. For example, after determining the risk factor for the nth invoice of the particular PO, data management system 110 may evaluate actions associated with the particular PO. In some situations, the actions may be based on the risk factor.

As an example, the actions may include reaching out to customers to settle invoices in the event the projected amount for the nth invoice cycle exceeds the amount allocated for the particular PO. Additionally, or alternatively, the actions may include enabling the particular PO to be renewed prior to an expiration date of the particular PO. Additionally, or alternatively, the actions may include performing analytics based on other POs. For example, the actions may include identify types of POs that are subject to disputes. The types of POs may be based on geographical areas (e.g., one or more countries), may be based on business units, among other examples.

Data management system 110 may provide actionable and nonactionable insights into a PO by leveraging risk factors and evaluating a status of a particular PO through the reinforcement learning model. A reinforcement learning agent, of the reinforcement learning model, may determine an impact of the actions on a performance of the particular PO. In this regard, data management system 110 may determine evaluate the actions based on the performance of the particular PO. The performance of the particular PO may indicate whether the particular PO is to be subject to dispute (e.g., based on discrepancies regarding the allocated amount for the particular PO, actual amounts of the invoices, and/or forecasted amounts of forecasted invoices).

In some examples, data management system 110 may determine the performance of the particular PO based on the following formula:

$${PO}_{performance} = f ( R , cust\_portfolio , past\_PO \_performance ) \qquad ( Formula 4 )$$

where PO_{performance} is the performance of the particular PO, R is the risk factor, cust_portfolio is the customer portfolio, and the past_PO_performance is the past PO performance of the particular PO.

The risk factor denotes the potential of a PO over-exhausting its amount, while the customer portfolio integrates with customer relationship (whether a new customer versus returning customer), past PO performance if returning customer, size of PO opportunity (enterprise customer versus mid-zed, PO amount, number of services requested, geography of PO, etc.). It also takes in the external environmental factors like market trends, inflation, customer comments etc. This translates into actionable and non-actionable recommendations to improve the health of a PO.

In some situations, data management system 110 may assess risk models and/or rewards functions that are proportional to the comparative PO performance analysis of the particular PO. The actions suggested by the reinforcement learning agent (based on the reinforcement learning model) may output (e.g., to user device 115) to assist a user associated with the particular PO.

In some implementations, data management system 110 (e.g., the reinforcement learning agent) may determine a reward associated with the reinforcement learning model using the following formula:

$${R}_{e} = \sum f ( A , S ) \qquad ( Formula 5 )$$

where Rₑ is the reward which is a function directly proportional to a change in the performance of the PO as a result of performing the actions, A is the set of actions taken by the reinforcement learning agent to determine the viability of the actions, and S is the set of states which are indicative of prior and post actions A after the actions have been taken (e.g., when action upon the state with feature/parameters at a given time instant T).

As an example with respect to the states, if the action is to renew the particular PO, a pre-state of the particular PO is that the particular PO has not been renewed and the post-state is whether the particular PO has been renewed.

The reward function Rₑ is used to determine the set of actions the reinforcement learning agent is to take for a desired outcome. If Rₑ value is lower than the original R, the set of actions may not improve the PO_{performance}, thus the actionable insight strategy may be negated and other information regarding the actionable insight strategy may be discarded.

If Rₑ value is higher than the original R, then data management system 110 (e.g., the reinforcement learning agent) may provide actionable insights such as proactively reaching out to customers in case of non-settlement of invoices, enabling PO renewal ahead of expiration, among other examples explained above. Additionally, or alternatively, data management system 110 (e.g., the reinforcement learning agent) may provide nonactionable insights which may include performance analytics of PO specific to a region or business unit, invoicing disputes, and understanding how each team operates their orders among other examples.

As shown in FIG. 1E, and by reference number 180, data management system 110 may perform an action regarding the particular PO. For example, after evaluating the actions associated with the particular PO, data management system 110 may perform the action. In some implementations, data management system 110 may provide a recommendation to user device 115. The recommendation may indicate that the particular PO is to be renewed prior to the expiration, indicate that invoices of the particular PO are to be settled, may provide analytics regarding different POs, among other examples.

Additionally, or alternatively, data management system 110 may generate and provide instructions to user device 115 to instruct user device 115 to renew the particular PO prior to the expiration date, and to settle the invoices among other examples. Additionally, or alternatively, data management system 110 may generate and provide instructions to one or more computing devices 105 to instruct the one or more computing devices 105 to renew the particular PO prior to the expiration date, and to settle the invoices among other examples.

Implementations described herein are directed to providing an integrated analysis combining customer portfolio for a PO, a risk factor, and a past performance of the PO. Additionally, implementations described herein focus on deriving the most correlated labels from a large number of POs labels and a large number of invoices labels through a feature engineering method that is powered by an NLP model (which solves the issue of missing data). Implementations described herein are directed at conducting multi-pairing on the correlated features. Furthermore, implementations described herein are directed to defining and calculating a risk factor (for a PO) that indicates a number of invoices that be used to exhaust the funds allocated by the PO.

For at least the foregoing reasons, implementations described herein may preserve computing resources, network resources, and other resources that would have otherwise been used to perform complex data mapping. Additionally, implementations described herein may preserve computing resources, network resources, and other resources that would have otherwise been used to remedy discrepancies with POs and invoices.

As indicated above, FIGS. 1A-1E are provided as an example. Other examples may differ from what is described with regard to FIGS. 1A-1E. The number and arrangement of devices shown in FIGS. 1A-1E are provided as an example. A network, formed by the devices shown in FIGS. 1A-1E may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

FIG. 2 is a diagram of an example computing environment 200 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 contains an example of an environment for the execution of at least some of the computer code involved in performing the inventive methods, such as digital content analyzer code 250. In addition to block 250, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and block 250, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

COMPUTER 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

PROCESSOR SET 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in block 250 in persistent storage 213.

COMMUNICATION FABRIC 211 is the signal conduction path that allows the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

PERSISTENT STORAGE 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface-type operating systems that employ a kernel. The code included in block 250 typically includes at least some of the computer code involved in performing the inventive methods.

PERIPHERAL DEVICE SET 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

NETWORK MODULE 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 203 is any computer system that is used and controlled by an end user (for example, a customer of an enterprise that operates computer 201) and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

REMOTE SERVER 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

PUBLIC CLOUD 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

FIG. 3 is a diagram of example components of a device 300, which may correspond to computing devices 105, data management system 110, and/or user device 115. In some implementations, computing devices 105, data management system 110, and/or user device 115 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

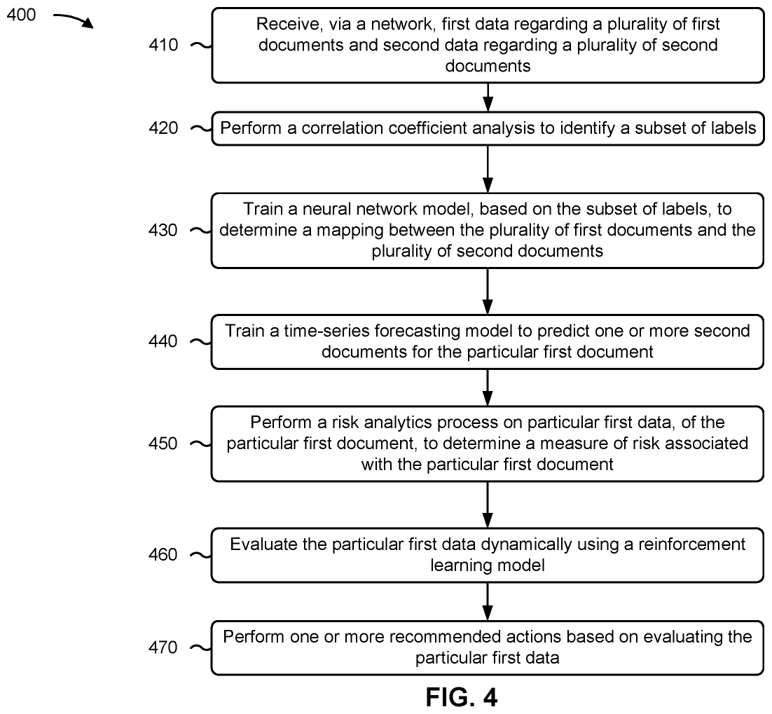

FIG. 4 is a flowchart of an example process 400 associated with mapping invoices to purchase orders and assessing risks associated with the purchase orders. In some implementations, one or more process blocks of FIG. 4 may be performed by a data management system (e.g., data management system 110). In some implementations, one or more process blocks of FIG. 4 may be performed by another device or a group of devices separate from or including the data management system, such as computing devices (e.g., computing devices 105) and/or a user device (e.g., user device 115). Additionally, or alternatively, one or more process blocks of FIG. 4 may be performed by one or more components of device 300, such as processor 320, memory 330, storage component 340, input component 350, output component 360, and/or communication interface 370.

As shown in FIG. 4, process 400 may include receiving, via a network, first data regarding a plurality of first documents and second data regarding a plurality of second documents (block 410). For example, the data management system may receive, via a network, first data regarding a plurality of first documents and second data regarding a plurality of second documents, wherein the first data and the second data are received from different devices, as described above. In some implementations, the first data and the second data are received from different devices.

As further shown in FIG. 4, process 400 may include performing a correlation coefficient analysis to identify a subset of labels (block 420). For example, the data management system may perform a correlation coefficient analysis to identify a subset of labels, as described above.

As further shown in FIG. 4, process 400 may include training a neural network model based on the subset of labels to determine a mapping between the plurality of first documents and the plurality of second documents (block 430). For example, the data management system may train a neural network model based on the subset of labels to determine a mapping between the plurality of first documents and the plurality of second documents, as described above. In some implementations, the mapping indicates that one or more second documents, of the plurality of second documents, are associated with a particular first document of the plurality of first documents.

As further shown in FIG. 4, process 400 may include training a time-series forecasting model to predict one or more additional second documents for the particular first document (block 440). For example, the data management system may train a machine learning model to predict one or more additional second documents for the particular first document, as described above.

As further shown in FIG. 4, process 400 may include performing a risk analytics process on particular first data, of the particular first document, to determine a measure of risk associated with the particular first document (block 450). For example, the data management system may perform a risk analytics process on particular first data, of the particular first document, to determine a measure of risk associated with the particular first document, wherein the measure of risk is determined based on the one or more additional second documents, as described above. In some implementations, the measure of risk is determined based on the one or more additional second documents.

As further shown in FIG. 4, process 400 may include evaluating the particular first data dynamically using a reinforcement learning model (block 460). For example, the data management system may evaluate the particular first data dynamically using a reinforcement learning model, wherein the particular first data is evaluated based on the measure of risk, as described above. In some implementations, the particular first data is evaluated based on the measure of risk.

As further shown in FIG. 4, process 400 may include performing recommended actions based on evaluating the particular first data (block 470). For example, the data management system may perform recommended actions based on evaluating the particular first data, as described above.

In some implementations, process 400 includes analyzing the first data and the second data to determine matches between first document labels of the particular first document and second document labels of one or more second documents of the plurality of second documents, assigning values based on analyzing the first data and the second data to determine the matches, wherein a first value is assigned to indicate a match between a first document label of the particular first document and a second document label of a second document, and wherein a second value is assigned to indicate a match between a second document label of the particular first document and a second document label of the second document, and generating a data structure that includes multiple entries with the first value and the second value.

In some implementations, performing the correlation coefficient analysis comprises using the data structure, to identify, as a subset of most correlated labels, a subset of the first document labels and a subset of the second document labels that are most correlated out of the first document labels and the second document labels, and training the neural network model to determine matches between the first documents and the second documents, wherein the neural network model is trained using the identified subset of most correlated labels.

In some implementations, training the machine learning model comprises training the machine learning model to predict one or more expected amounts of the one or more additional second documents for one or more upcoming billing cycles.

In some implementations, performing the risk analytics process comprises determining the measure of risk of the particular first document based on an expiration time of the particular first document and a remaining amount of the particular first document.

In some implementations, evaluating the particular first data dynamically using the reinforcement learning model comprises determining a performance of the particular first document based on the measure of risk, information regarding an entity associated with the particular first document, and historical performance of first documents associated with the entity, and determining whether actions, identified for the particular first document, improve the performance of the particular first document.

In some implementations, performing the action comprises determining that the actions improve the performance of the particular first document, and providing the actions as recommendations to improve the performance of the particular first document.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method comprising:
receiving, via a network, first data regarding a plurality of first documents and second data regarding a plurality of second documents,
wherein the first data and the second data are received from different devices;
performing a correlation coefficient analysis to identify a subset of labels;
training a neural network model, based on the subset of labels, to determine a mapping between the plurality of first documents and the plurality of second documents,
wherein the mapping indicates that one or more second documents, of the plurality of second documents, are associated with a particular first document of the plurality of first documents;
training a time-series forecasting model to predict one or more forecasted second documents for the particular first document;
performing a risk analytics process on particular first data, of the particular first document, to determine a measure of risk associated with the particular first document,
wherein the measure of risk is determined based on the one or more forecasted second documents;
evaluating the particular first data dynamically using a reinforcement learning model,
wherein the particular first data is evaluated based on the measure of risk; and
performing one or more recommended actions based on evaluating the particular first data.

2. The computer-implemented method of claim 1, further comprising:
parsing the first data and the second data, using a parsing algorithm, to obtain parsed first data and parsed second data;
analyzing the parsed first data and the parsed second data to determine matches between first document labels of the particular first document and second document labels of one or more second documents of the plurality of second documents;
assigning values based on analyzing the parsed first data and the parsed second data to determine the matches,
wherein a first value is assigned to indicate a match between a first document label of the particular first document and a second document label of a second document, and
wherein a second value is assigned to indicate no match between a second document label of the particular first document and a second document label of the second document; and
generating a data structure that includes multiple entries including the first value and the second value.

3. The computer-implemented method of claim 2, wherein performing the correlation coefficient analysis comprises:
performing the correlation coefficient analysis to identify, as a subset of most correlated labels, a subset of the first document labels and a subset of the second document labels that are most correlated out of the first document labels and the second document labels; and
training the neural network model to determine matches between the first documents and the second documents,
wherein the neural network model is trained using the identified subset of most correlated labels.

4. The computer-implemented method of claim 1, wherein training the time-series forecasting model comprises:
training the time-series forecasting model to predict one or more expected amounts of the one or more forecasted second documents for one or more upcoming billing cycles.

5. The computer-implemented method of claim 1, wherein performing the risk analytics process comprises:
determining the measure of risk of the particular first document based on an expiration time of the particular first document and a remaining amount of the particular first document.

6. The computer-implemented method of claim 1, wherein evaluating the particular first data dynamically using the reinforcement learning model comprises:
determining a performance of the particular first document based on the measure of risk, information regarding an entity associated with the particular first document, and historical performance of first documents associated with the entity; and
determining whether actions, identified for the particular first document, improve the performance of the particular first document.

7. The computer-implemented method of claim 6, wherein performing the action comprises:
determining that the actions improve the performance of the particular first document;
and
providing the actions as recommendations to improve the performance of the particular first document.

8. A computer program product comprising:
one or more computer readable storage media, and program instructions collectively stored on the one or more computer readable storage media, the program instructions comprising:
program instructions to receive purchase order (PO) data regarding one or more purchase orders (POs) and invoice data regarding a plurality of invoices;
program instructions to perform a correlation coefficient analysis to identify a subset of labels;
program instructions to train a neural network model based on the subset of labels to determine a mapping between the plurality of invoices and the one or more POs,
wherein one or more invoices, of the plurality of invoices, are associated with a particular PO of the one or more POs;
program instructions to generate a time-series forecasting model to predict one or more forecasted invoices for the particular PO;
program instructions to perform a risk analytics process on particular PO data, of the particular PO, to determine a measure of risk associated with the particular PO,
wherein the measure of risk is determined based on the one or more forecasted invoices;
program instructions to evaluate the particular PO data dynamically using a reinforcement learning model,
wherein the particular PO data is evaluated based on the measure of risk; and
program instructions to perform an action based on evaluating the particular PO data.

9. The computer program product of claim 8, wherein the program instructions further comprise:
program instructions to analyze the PO data to identify one or more first labels with missing values;
program instructions to analyze the invoice data to identify one or more second labels with missing values;
program instructions to analyze the PO data, using a natural language processing algorithm, to identify one or more first values for the one or more first labels; and
program instructions to analyze the invoice data, using the natural language processing algorithm, to identify one or more second values for the one or more second labels.

10. The computer program product of claim 8, wherein the program instructions further comprise:
program instructions to analyze the PO data and the invoice data to determine matches between PO labels of the particular PO and invoice labels of one or more invoices of the plurality of invoices;
program instructions to assign values based on analyzing the PO data and the invoice data to determine the matches,
wherein a first value is assigned to indicate a match between a first PO label of the particular PO and a first invoice label of an invoice, and
wherein a second value is assigned to indicate a match between a second PO label of the particular PO and a second invoice label of the invoice; and
program instructions to generate a data structure that includes multiple entries with the first value and the second value.

11. The computer program product of claim 10, wherein the program instructions to perform the correlation coefficient analysis comprise:
program instructions to perform the correlation coefficient analysis to identify, as a subset of most correlated labels, a subset of the PO labels and a subset of the invoice labels that are most correlated out of the PO labels and the invoice labels; and
program instructions to train a neural network model to determine matches between POs and invoices,
wherein the neural network model is trained using the identified subset of most correlated labels.

12. The computer program product of claim 8, wherein the program instructions to perform the risk analytics process comprise:
program instructions to determine the measure of risk of the particular PO based on an expiration time of the particular PO and a remaining amount of the particular PO.

13. The computer program product of claim 8, wherein the program instructions to evaluate the particular PO data dynamically using the reinforcement learning model comprise:
program instructions to determine a performance of the particular PO based on the measure of risk, information regarding an entity associated with the particular PO, and historical performance of POs associated with the entity; and
program instructions to determine whether actions, identified for the particular PO, improve the performance of the particular PO.

14. The computer program product of claim 13, wherein the program instructions to perform the actions comprise:
program instructions to determine that the actions improve the performance of the particular PO; and
program instructions to provide the actions as recommendations to improve the performance of the particular PO.

15. A system comprising:
one or more devices configured to:
perform a correlation coefficient analysis to identify a subset of most correlated labels out of labels of a plurality of invoices and labels of a plurality of purchase orders (POs);
train a neural network model, based on the subset of most correlated labels, to determine a mapping between the plurality of invoices and the plurality of POs,
wherein the mapping indicates that one or more invoices, of the plurality of invoices, are associated with a particular purchase order (PO) of the plurality of POs;
train a time-series forecasting model to predict one or more forecasted invoices for the particular PO;
determine a measure of risk associated with the particular PO,
wherein the measure of risk is determined based on the one or more forecasted invoices;
evaluate particular PO data, of the particular PO, dynamically using a reinforcement learning model,
wherein the particular PO data is evaluated based on the measure of risk; and
perform one or more recommended actions based on evaluating the particular PO data.

16. The system of claim 15, wherein, to evaluate the particular PO data dynamically using the reinforcement learning model, the one or more devices are configured to:
determine a performance of the particular PO based on the measure of risk, information regarding an entity associated with the particular PO, and historical performance of POs associated with the entity; and
determine whether actions, identified for the particular PO, improve the performance of the particular PO.

17. The system of claim 15, wherein, to perform the actions, the one or more devices are configured to:
determine that the actions improve the performance of the particular PO; and
provide the actions as recommendations to improve the performance of the particular PO.

18. The system of claim 15, wherein the one or more devices are configured to:
receive PO data regarding a plurality of purchase orders (POs) and invoice data regarding a plurality of invoices,
wherein the PO data and the invoice data are received from different devices associated with different cloud systems;
analyze the PO data to identify one or more first labels with missing values;
analyze the invoice data to identify one or more second labels with missing values;
analyze the PO data, using a natural language processing algorithm, to identify one or more first values for the one or more first labels; and
analyze the invoice data, using the natural language processing algorithm, to identify one or more second values for the one or more second labels.

19. The system of claim 15, wherein the one or more devices are configured to:
receive, via a network, PO data regarding the plurality of POs and invoice data regarding the plurality of invoices;
analyze the PO data and the invoice data to determine matches between PO labels of the particular PO and invoice labels of one or more invoices of the plurality of invoices;
assign values based on analyzing the PO data and the invoice data to determine the matches,
wherein a first value is assigned to indicate a match between a first PO label of the particular PO and a first invoice label of an invoice, and
wherein a second value is assigned to indicate a match between a second PO label of the particular PO and a second invoice label of the invoice; and
generate a data structure that includes multiple entries with the first value and the second value.

20. The system of claim 15, wherein, to determine the measure of risk, the one or more devices are configured to:
determine the measure of risk of the particular PO based on an expiration time of the particular PO and a remaining amount of the particular PO.
